(19) United States
(12) Patent Application Publication
(10) Pub. No.: US 2024/0173775 A1
(43) Pub. Date: May 30, 2024

(54) METHOD OF PRODUCING A MEDICAL IMPLANT ADOPTING ADDITIVE MANUFACTURING

(71) Applicant: National Cheng Kung University, Tainan (TW)

(72) Inventors: Ming-Long Yeh, Tainan (TW); Guan-Lin Wu, Tainan (TW); Chin-En Yen, Tainan (TW); Ching Feng, Tainan (TW)

(21) Appl. No.: 18/518,644

(22) Filed: Nov. 24, 2023

Related U.S. Application Data
(60) Provisional application No. 63/384,952, filed on Nov. 24, 2022.
(60) Provisional application No. 63/527,076, filed on Jul. 16, 2023.

(51) Int. Cl. B22F 12/41; B22F 10/64

(52) U.S. Cl. CPC B22F 12/41; B22F 10/64; B22F 2301/058; B33Y 10/00

(57) ABSTRACT

The present invention discloses a method of producing a medical implant adopting additive manufacturing including: distributing magnesium-zinc-zirconium alloy powder on a substrate to form a powder layer; generating a high-energy beam within a specific power range and directing the high-energy beam to the powder layer through a probe to sinter a region of the powder layer; distributing the plurality of magnesium-zinc-zirconium alloy powder on the sintered region of the powder layer; and repeating above steps until the medical implant is formed.

### CROSS REFERENCE

This non-provisional application claims benefit of U.S. Provisional Application No. 63/384,952, filed on Nov. 24, 2022, and U.S. Provisional Application No. 63/527,076, filed on Jul. 16, 2023, the contents thereof are incorporated by reference herein.

### FIELD OF THE INVENTION

This invention relates to the medical implant field, in particular, to a method of producing a medical implant adopting additive manufacturing.

### BACKGROUND OF THE INVENTION

When bones suffer damage or displacement due to external forces, the bone repairing process, from the formation of a bone callus to the development of new bone tissue, typically takes three to six months or even longer. Nevertheless, utilizing various metallic implants can offer additional mechanical support to the affected area. Such that it can accelerate the process of bone reconstruction and reduce the time of post-injury reconstruction for patients.

The most commonly adopted elements for fixing fractures in orthopedic surgery are bone screws and bone plates. However, traditional bone plates may not always perfectly match the bone's morphology or the specific needs of individual patients in terms of their daily activity. Moreover, these implants made from nondegradable materials often require a second, undesirable operation to remove the implant, which increases the risk of damaging healed tissues and the risk of infection.

Biodegradable magnesium alloys have an excellent biocompatibility and osteoconductive properties. However, due to their high chemical reactivity, it is difficult to adopt magnesium to produce metallic implants produced through additive manufacturing.

### SUMMARY OF THE INVENTION

In one embodiment of the present disclosure provides a method of producing a medical implant adopting additive manufacturing, including: distributing magnesium-zinc-zirconium alloy powder on a substrate to form a powder layer; generating a high-energy beam within a specific power range and directing the high-energy beam to the powder layer through a probe to sinter a region of the powder layer; distributing the plurality of magnesium-zinc-zirconium alloy powder on the sintered region of the powder layer; and repeating above steps until the medical implant is formed.

Preferably, a particle diameter of the magnesium-zinc-zirconium alloy powder is within a range of 50 μm to 100 μm.

Preferably, a moving speed of the probe is within a range of 200 mm/s to 800 mm/s and a power of the high-energy beam is within a range of 90 watts to 130 watts.

Preferably, a diameter of the high-energy beam is within a range of 50 μm to 100 μm.

Preferably, an amount of zinc contained in the magnesium-zinc-zirconium alloy powder does not exceed 5% by weight and an amount of zirconium contained in the magnesium-zinc-zirconium alloy powder does not exceed 0.5% by weight.

Preferably, a thickness of the powder layer is in a range from 50 μm to 100 μm.

Preferably, the substrate is at 100 to 200 degree.

Preferably, the method further includes putting the medical implant in a furnace for 1.5 hours; heating the medical implant to an absolute temperature of 583 degrees and maintaining it for 2 hours; quenching the medical implant to room temperature.

Preferably, the method further includes putting the medical implant in a furnace for 1 hour; heating the medical implant to an absolute temperature of 433 degrees and maintaining it for 24 hours.

Preferably, putting the medical implant in a furnace for 1.5 hours; heating the medical implant to an absolute temperature of 583 degrees, and maintaining it for 2 hours; quenching the medical implant to room temperature; putting the medical implant back in the furnace for 1 hour; heating the medical implant to an absolute temperature of 433 degrees and maintaining it for 24 hours; air-cooling the medical implant to room temperature.

Preferably, the method further includes immersing the medical implant in a 42% hydrofluoric acid solution for 24 hours to form an anti-oxidation layer having a thickness of 2 to 5 μm.

Through the method of manufacturing medical implants (e.g., bone plates) using the alloy additive manufacturing device provided in the present disclosure, along with the appropriate high-energy beam power and moving speed of the probe, high-density medical implants can be obtained. By adjusting the composition of the metal powder, the biodegradable medical implants that can naturally degrade in the human body and be absorbed or excreted by the human body can be obtained.

### BRIEF DESCRIPTION OF THE DRAWINGS

FIG. 1 is a schematic diagram of an alloy additive manufacturing device in one embodiment of the present disclosure.

FIG. 2 is a flowchart of a method of producing a medical implant adopting additive manufacturing in one embodiment of the present disclosure.

FIG. 3 illustrates the relative density of the specimen corresponding to different moving speed of the probe and different power of the high-energy beam in one embodiment of the present disclosure.

### DETAILED DESCRIPTION OF THE INVENTION

In order to make the aforementioned and/or other purposes, benefits, and features of the present disclosure clearer and more understandable, the following detailed description is provided, using preferred embodiments as examples.

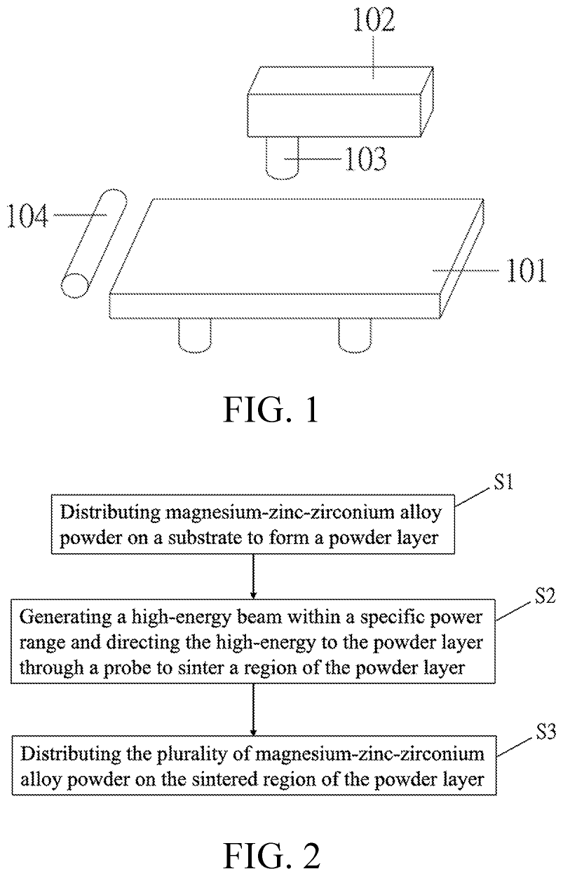

Please refer to FIG. 1. FIG. 1 is a schematic diagram of an alloy additive manufacturing device in one embodiment of the present disclosure. The alloy additive manufacturing device 1 includes: a substrate 101, a high-energy beam generator 102, a probe 103 and a powder distributor 104. The powder distributor 104 is connected to a movable platform, and through the movement of the movable platform, the powder distributor 104 can evenly distribute the metal powder on the substrate 101. The high-energy beam generator 102 is located above the substrate 101 and is connected to another movable platform. The high-energy beam generated by the high-energy beam generation device 102 is directed onto the substrate 101 through the probe 103. Preferably, the high-energy beam may be a laser.

The following describes the method of manufacturing medical implants (e.g., bone plates) using the alloy additive manufacturing device. Please refer to FIG. 2, FIG. 2 is a flowchart of a method of producing a medical implant adopting additive manufacturing in one embodiment of the present disclosure.

In step S1, first, in the process of manufacturing the specimen, the powder distributor 104 evenly distributes metal powder onto the substrate 101 to form a powder layer. Preferably, the thickness of the powder layer is in a range from 50 μm to 100 μm. The movable platform connected to the high-energy beam generator 102 moves to the corresponding position according to the design and the high-energy beam generator 102 generates the high-energy beam. It is noted that, before step S1, the additive manufacturing device should be filled with nitrogen gas and reduce the oxygen content below 500 ppm to ensure the manufacturing quality. In another embodiment of the present disclosure, the substrate 101 can be heated before manufacturing the specimen to reduce the temperature difference between the substrate 101 and the high-energy beam. Such that, the sintering quality can be improved. Preferably, the substrate 101 can be heated to 100 to 200 degree.

The high-energy beam generated by the high-energy beam generator 102 has a diameter of 50 to 100 μm. In one embodiment of the present disclosure, the diameter of the high-energy beam is 75 μm, and the scanning spacing of the probe 103 is 50 μm. Therefore, during each scan of the high-energy beam, one-third of the sintered portion is repeated, which improves the quality of sintering.

In step S2, the generated high-energy beam is directed onto the powder layer through the probe 103 to sinter the metal powder. During the sintering process, the movable platform continuously moves the high-energy beam generator 102 according to the design to sinter the powder layer to the form the predetermined image.

Then, in step S3, the substrate 101 moves downward a predetermined distance, and the powder distributor 104 distributes the metal powder on the substrate 101 again to form a new powder layer with a part of the newly distributed metal powder distributing on the sintered image. According to the design, the movable platform moves the high-energy beam generator 102 again while the high-energy beam generator 102 generates the high-energy beam to sinter the new powder layer. The above steps are repeated until the specimen is completed.

In one embodiment of the present disclosure, the metal powder may be magnesium-zinc-zirconium alloy powder with the amount of zinc contained in the magnesium-zinc-zirconium alloy powder does not exceed 5% by weight and the amount of zirconium contained in the magnesium-zinc-zirconium alloy powder does not exceed 0.5% by weight. Preferably, the particle diameter of the magnesium-zinc-zirconium alloy powder is within a range of 50 μm to 100 μm.

For the manufactured specimen, it is necessary to test the material characteristics, including crystallinity, surface roughness, and perform tensile tests to evaluate its mechanical properties such as elastic modulus, yield strength, tensile strength, and ductility. In one embodiment of the present disclosure, if the material characteristics or mechanical properties of the specimen do not meet the requirements, adjustments can be made to the manufacturing parameters. For example, when using the alloy additive manufacturing device, the material characteristics of the specimen are related to the moving speed of the probe 103 and the power of the high-energy beam during the manufacturing process. Therefore, by adjusting these two parameters, the material characteristics and mechanical properties of the specimen can be modified.

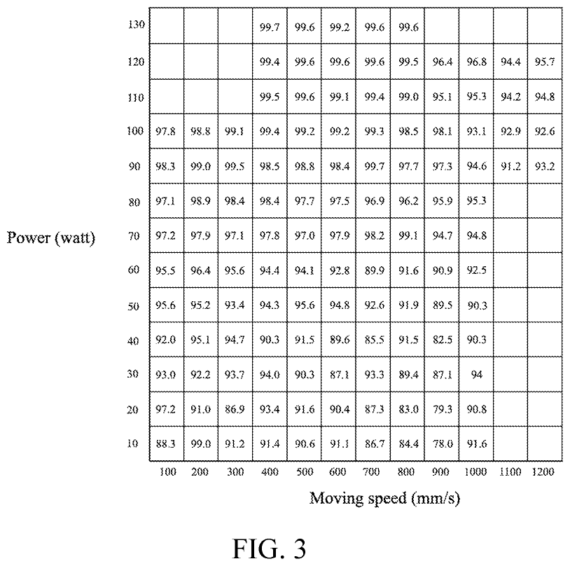

Please refer to FIG. 3, FIG. 3 illustrates the relative density of the specimen corresponding to different moving speed of the probe and different power of the high-energy beam in one embodiment of the present disclosure. The numbers shown in FIG. 3 represent the relative density of the specimens, with larger numbers indicating the higher density of the specimens. It is noted that if the number equals to 100, meaning there is no any hole in the specimen. Preferably, the specimen's relative density needs to be greater than 99 to meet the requirements. From FIG. 3, it can be noted that when the power of the high-energy beam is 90 watts and the moving speed of the probe 103 is 200 mm/s, the relative density of the specimen is 99. When the power of the high-energy beam is 90 watts and 100 watts, and the moving speed of the probe 103 is 300 mm/s, the relative densities of the specimens are 99.5 and 99.1, respectively. Furthermore, when the power of the high-energy beam is in the range of 100 to 130 watts and the moving speed of the probe 103 is between 400 and 800 mm/s, except the combination of the high-energy beam's power of 100 watts and the probe 103's moving speed of 400 mm/s, the relative densities of all other specimens are above 99.

On the other hand, the white squares shown in FIG. 3 indicates that the corresponding power of the high-energy beam and the moving speed of probe 103 cannot produce a specimen. For example, when the power of the high-energy beam is between 110 and 130 watts and the moving speed of probe 103 is between 100 and 300 mm/s, the specimen cannot be manufactured.

In another embodiment of the present disclosure, if the material characteristics or mechanical properties of the specimen do not meet the requirements, the specimen can undergo heat treatments, antioxidation treatments and other post-processing treatments to improve its mechanical properties, corrosion resistance, and surface properties.

The heat treatment may have three different types (T4, T5 and T6). For T4 type, putting the specimen in a furnace for 1.5 hours to heat the specimen to an absolute temperature of 583 degrees, and maintaining it for 2 hours, then quenching the specimen to room temperature. For T5 type, putting the specimen into the furnace for 1 hour to heat the specimen to an absolute temperature of 433 degrees, and maintaining it for 24 hours, then air-cooling the specimen to room temperature. For T6 type, putting the specimen into the furnace for 1.5 hours to heat the specimen to an absolute temperature of 583 degrees, and maintaining it for 2 hours, then quenching the specimen to room temperature. Then, putting the specimen back into the furnace for 1 hour to heat the specimen to an absolute temperature of 433 degrees, and maintaining it for 24 hours, then air-cooling the specimen to room temperature. The mechanical properties and the electrochemical properties of the specimen, after the heat treatment, are shown in Table 1 and Table 2 respectively.

TABLE 1

| | UTS | YS | E | Elongation | Hardness |
|---|---|---|---|---|---|
| | (MPa) | (MPa) | (GPa) | (%) | (HV) |
| Original specimen | 283 | 167 | 54.7 | 4.8 | 80.5 |
| T4 | 269 | 137 | 56.1 | 5.4 | 70.9 |
| T5 | 284 | 185 | 61.3 | 3.9 | 79.0 |
| T6 | 274 | 187 | 61.5 | 3.3 | 74.2 |

※UTS = Ultimate tensile strength, YS = Yield strength, E = Young's modulus

TABLE 2

| | E_{corr} (V) | i_{corr} (μA/cm²) | CR (mm/year) |
|---|---|---|---|
| T4 | −0.41 | 2.66 | 0.11 |
| T5 | −0.27 | 4.44 | 0.18 |
| T6 | −0.41 | 2.28 | 0.09 |

※E_{corr} = Corrosion potential, i_{corr} = Corrosion current density, CR = Corrosion rate

For antioxidation treatment, specifically, the specimen can be immersed in a 42% hydrofluoric acid solution for 24 hours to form an anti-oxidation layer having a thickness of 2 to 5 μm on the specimen's surface to enhance the anti-oxidation abilities of the specimen. The electrochemical properties of the specimen after the antioxidation treatment are shown in Table 3. It can be seen that after the antioxidation treatment, the specimen has the lowest corrosion rate.

TABLE 3

| | E_{corr} | i_{corr} | Rp | CR |
|---|---|---|---|---|
| | (V) | (μA/cm²) | (Ω) | (mm/year) |
| Pure Mg | −1.91 | 65.67 | 381 | 1.50 |
| Original specimen | −1.57 | 22.88 | 1093 | 0.52 |
| After antioxidation | −1.44 | 2.52 | 9913 | 0.06 |

※ E_{corr} = corrosion potential, i_{corr} = corrosion current density, Rp = Polarization resistance, CR = corrosion rate

In addition to conducting material characteristic tests on the specimen, biomechanical evaluation is also an important indicator for assessing the specimen. Firstly, the specimen is combined with magnesium screws and fixed to the animal bone for biomechanical testing to assess the fixation ability. Compression tests are performed to evaluate the biomechanical rigidity of the animal bone after fixing the specimen.

After evaluating the material characteristic and conducting biomechanical evaluation, the specimen is fixed at the site of a rabbit's humeral fracture to test the specimen's degradation capability and biocompatibility.

Through the method of manufacturing medical implants (e.g., bone plates) adopting the alloy additive manufacturing device provided in the present disclosure, along with the appropriate high-energy beam power and moving speed of the probe, high-density medical implants can be obtained. By adjusting the composition of the metal powder, the biodegradable medical implants, which can naturally degrade in the human body and be absorbed or excreted by the human body, can be obtained. Comparing to non-degradable medical implants made from titanium alloys and stainless steel, biodegradable medical implants do not require a second surgery for removal, thus avoiding the risks associated with additional surgical procedures.

The above description represents only preferred embodiments of the present invention, and the scope of the present invention should not be limited to these embodiments. Therefore, any simple equivalent changes and modifications made according to the scope of the patent claims and the content of the invention disclosure are still within the scope of the present invention.

What is claimed is:

1. A method of producing a medical implant adopting additive manufacturing, comprising:
distributing magnesium-zinc-zirconium alloy powder on a substrate to form a powder layer;
generating a high-energy beam within a specific power range and directing the high-energy to the powder layer through a probe to sinter a region of the powder layer;
distributing the plurality of magnesium-zinc-zirconium alloy powder on the sintered region of the powder layer; and
repeating above steps until the medical implant is formed.

2. The method of producing medical implants adopting additive manufacturing of claim 1, wherein a particle diameter of the magnesium-zinc-zirconium alloy powder is within a range of 50 μm to 100 μm.

3. The method of producing medical implants adopting additive manufacturing of claim 1, wherein a moving speed of the probe is within a range of 200 mm/s to 800 mm/s and a power of the high-energy beam is within a range of 90 watts to 130 watts.

4. The method of producing medical implants adopting additive manufacturing of claim 1, wherein a diameter of the high-energy beam is within a range of 50 μm to 100 μm.

5. The method of producing medical implants adopting additive manufacturing of claim 1, wherein an amount of zinc contained in the magnesium-zinc-zirconium alloy powder does not exceed 5% by weight and an amount of zirconium contained in the magnesium-zinc-zirconium alloy powder does not exceed 0.5% by weight.

6. The method of producing medical implants adopting additive manufacturing of claim 1, wherein a thickness of the powder layer is in a range from 50 μm to 100 μm.

7. The method of producing medical implants adopting additive manufacturing of claim 1, wherein the substrate is at 100 to 200 degree.

8. The method of producing medical implants adopting additive manufacturing of claim 1, wherein the method further comprises:
putting the medical implant in a furnace for 1.5 hours;
heating the medical implant to an absolute temperature of 583 degrees, and maintaining it for 2 hours;
quenching the medical implant to room temperature.

9. The method of producing medical implants adopting additive manufacturing of claim 1, wherein the method further comprises:
putting the medical implant in a furnace for 1 hour;
heating the medical implant to an absolute temperature of 433 degrees, and maintaining it for 24 hours;
air-cooling the medical implant to room temperature.

10. The method of producing medical implants adopting additive manufacturing of claim 1, wherein the method further comprises:
putting the medical implant in a furnace for 1.5 hours;
heating the medical implant to an absolute temperature of 583 degrees, and maintaining it for 2 hours;
quenching the medical implant to room temperature;
putting the medical implant back in the furnace for 1 hour;
heating the medical implant to an absolute temperature of 433 degrees, and maintaining it for 24 hours;
air-cooling the medical implant to room temperature.

11. The method of producing medical implants adopting additive manufacturing of claim 1, wherein the method further comprises:
immersing the medical implant in a 42% hydrofluoric acid solution for 24 hours to form an anti-oxidation layer having a thickness of 2 to 5 μm.
